(19) United States
(12) Patent Application Publication
(10) Pub. No.: US 2004/0024484 A1
(43) Pub. Date: Feb. 5, 2004

(54) Textile machine with multiple work stations and a machine bus for communication

(75) Inventors: Bernd Bahlmann, Schrobenhausen (DE); Mario Maleck, Kipfenberg (DE); Erwald Lenk, Ingolstadt (DE)

Correspondence Address: STEPHEN E. BONDURA, DORITY & MANNING, P.A., P.O. BOX 1449, GREENVILLE, SC, 29602-1449, US

(73) Assignee: RIETER INGOLSTADT SPINNEREIMASCHINENBAU AG.

(21) Appl. No.: 10/392,060

(22) Filed: Mar. 19, 2003

(30) Foreign Application Priority Data
Mar. 21, 2002 (DE) 102 12 712.3

(51) Int. Cl. G06F 19/00

(52) U.S. Cl. 700/130

(57) ABSTRACT

The invention concerns a textile machine (10) with a multiplicity of workstations (41a-d), one electronic device (42) per workstation, a central machine control (20, 22), a machine bus (25) for communication between the machine control and each or possibly a group (30a-d) of electronic device(s) and a sensor apparatus (43) for each workstation. In accord with the invention is provided a central evaluation unit (24) for the assessment of sensor data from the sensor apparatuses (44), whereby the sensor data embrace continually measured characteristic values and/or the quality or signal data derived therefrom, the central evaluation unit (24) is connected by means of a first communication connection (23, 23) with the machine control (20, 22) or so connected by the machine bus (25), the sensor apparatuses (43) are connected with the evaluation unit (24) through a second communication connection (23, 25, 31a, 40, 44, 45) and the second communication connection embraces at least the machine bus (25) and the first communication connection (23, 23). A procedure for the tmnsmission of sensor data in the case of a textile machine provides the transmission of the data from sensor apparatuses (43) to a central evaluation unit (24) at least by interconnected pathways and through a machine bus (25) of the textile machine (10).

The invention concerns a textile machine with a multiplicity of workstations, a central machine control and a machine bus for communication between the machine control and each, or possibly a group of electronic devices associated with each workstation, wherein a sensor device is located at each workstation.

A textile machine made known by EP 0 832 997 A2 possesses a multiplicity of workstations and respectively, a workstation electronic device is placed at each said workstation. The workstation electronic devices are respectively grouped with a section controller by a connection through a data interface. Section controllers are, in turn, interconnected by a data line to a machine bus. The machine bus is further connected to a machine center in such a manner, that the machine center controls the sectional controllers which are connected in parallel along the machine bus. This arrangement accordingly provides control for the workstation electronic devices. At each workstation electronic device a thread-monitor is located, which detects the presence of a thread at its assigned workstation and in a case of absence of a thread, transmits a corresponding signal to the workstation electronic device. The body of information transmitted from the thread-monitor, that is, the data throughput demanded for this purpose, is very small, since the information provided, i.e. “Thread Lacking”, for example, is only given out by a break in the running thread. This is an event which occurs but seldom.

In the case of a disclosed communication structure, namely from WO 85/01073, the workstations of a textile machine are monitored by respective warning instruments. In this way, the sensors are placed at each workstation and accordingly transmit analog thread-signals to a processor. Analog thread-signals from a group of monitoring sensors can be evaluated by one processor and subsequently transmitted in digital form through a communication channel to a communication processor. Several processors are connected in parallel onto the said communication channel. The data, which are transmitted from the processors to the communication channel, are received by a centralized unit of the thread monitoring system and are there evaluated. From this centralized unit, in turn, alarm signals and commands for intervention are sent over a communication connection to a control center of the textile machine. Because of the thread-signal, the monitoring at the workstations requires a stand-alone communication structure.

It is the purpose of the invention to create an economical communication structure for the monitoring of the workstations of a textile machine.

This purpose is achieved by the features of claims 1 and/or 12.

The textile machine in accord with claim 1 encompasses a multiplicity of workstations and respectively one electronic device per workstation. A workstation is usually a spinning station of an open end spinning machine, a winding point, or the like. The textile machine is monitored and regulated by a machine control center in order, for example, to detect failure at a workstation, to take individual workstations out of production, or to shut down or to start up an entire machine. By means of a machine bus, the machine control remains in communication with the electronic devices of the workstations or in some cases with a group of such electronic devices. The communication, in this arrangement, is bidirectional, so that commands are transmitted from the machine control to the electronic device or, conversely, error conditions captured by the by the electronic device at the work station are sent to the machine control.

Besides the electronic device, at each workstation a sensor apparatus is installed, which carries out a supervisory function. With its high scanning frequency of a plurality of values per second the sensor apparatus picks up a characteristic values at the workstation. Extremely advantageously in this case, a sensor is included in the apparatus for the monitoring of the thread quality of the thread produced or processed at the individual workstation.

Besides the centralized machine control, a central evaluation unit is assigned to the textile machine for the evaluation of sensor data and/or the data which are therefrom derived. To obtain a substantially reduced data throughput, the sensor data capture, in this arrangement, primary data, which are generated at each sensor, or, conversely, the quality or signal data derived therefrom.

The central evaluation unit, with this two-way circuit, makes decisions overriding the sensors in regard to the textile machine. When, the thread quality is monitored by the sensor apparatus, then the advantage of this override is that from the thread quality values of any one of the individual sensors, the central evaluation unit can make one evaluation which governs all workstations on the textile machine. The central evaluation unit weighs, in this manner, the primary sensor data, the data corresponding to the measured values, and advantageously the secondary quality or signal data derived therefrom. This derived secondary quality or signal data include, for example, classification information for the thread, thread fault-signals, technical alarms regarding the operational readiness of the sensor apparatus or the like. The central evaluation unit can proceed still further in the processing of the derived, secondary quality-data For instance the evaluation unit can execute spectrograms of the thread quality and determine CV-values. This can be done either for all workstations of the textile machine or for individual workstations.

The central evaluation unit is connected by a first communication line with the machine control or, preferably, is directly connected to the machine bus. By the said direct connection of the evaluation unit through the first communication line to the machine bus, the quantity of distributable sensor data to be forwarded from the machine control to the central evaluation unit is substantially reduced. In this way, a diminution of the load on the machine control is attained. The sensor apparatuses are connected by a second communication line to the evaluation unit, wherein the second communications line includes at least the machine bus and the first communication line. With this advantage, the transmission of the sensor data for each of the sensor apparatuses to the central evaluation unit will at least be to some extent picked up on the communication and control structure of the textile machine. It then becomes unnecessary to provide a dedicated, separate communication structure for the sensor apparatus and its evaluation unit. In this way, the expense on the wiring between the sensor apparatuses and the central evaluation unit is considerably reduces If such provision has been made, in this case, for example, also the adjustment of the sensor apparatus can be carried out over this communication structure with the use of the machine bus. In this case, it is of particular advantage to design the second communication line to be bidirectional in nature. Among other advantages, the reaction times are considerably reduced, when the sensor apparatuses emit signals, which, for instance, are to be evaluated only at the central machine control, since the central evaluation unit, in this case, need not be interposed.

As already mentioned, it is preferential, that from the primary, measured characteristic values for data reduction, only the quality or signal data derived therefrom need be transmitted over the communication structure. The transmission of this secondary data is carried out either continuously, that is, as data accumulates with each sensor apparatus, or packetwise, that is, upon the accumulation of a certain quantity of data or upon a demand from the central evaluation unit. Particularly advantageously, the transmission can occur at predetermined time periods, for instance in timed minute spans, wherein the sensor apparatuses are time-adjusted to release their data to the central evaluation unit in an appointed time window.

In the case of a large number of workstations per textile machine, advantageously, correspondingly more workstations would be assigned to a group, that is, coalesced into a section, which in turn would be connected to a section controller which would be tied into the machine bus. The connection between the group of electronic devices with the section unit can be a star-shaped connection, preferably by a section bus. Likewise, in this case, the sensor apparatuses are subdivided again groupwise, whereby, advantageously, the size of the group and the groupings hereof are compatible to those of the electronic apparatus of the workstations. The communication between the central evaluation unit and the sensor apparatuses is done, in this case, sectionally through a third communication line, which runs between a section and the sensor apparatuses. The third communication connection can be provided directly between the section units and the sensor apparatuses or can be accomplished by an interposed switching in of the sectional bus. In the case of a direct connection between the controllers and the section units, this is also advantageously constructed in star formation.

In a further embodiment of the present invention, the sensor apparatuses are not connected directly with the section units, nor with the section bus, but by a sensor-section-element, on which, once again, the sensors are star connected with one another, or communicate with each other by a sensor-section bus.

Forwarding of the sensor data is done, in this case, from the sensor apparatus to the sensor section unit and from this to the section unit either by section bus or by direct connection thereto. Provision can also be made, that from this sensor apparatus the communication can be accomplished directly to machine bus.

Very advantageously, each sensor apparatus possesses a communication means and/or an evaluation unit for making available secondary, derived quality or signal data. With this communication means, digital signals can be directly transmitted and, in the case of a bidirectional tie, also received.

If the captured measured values, i.e., the primary characteristic values, have been already evaluated by the sensor apparatus, then the data to be transmitted have been substantially reduced. If the sensor apparatus possesses both a communication means as well as an evaluation unit, then, an autonomically reacting sensor apparatus is in place. If this is the case, then a sensor section unit may be dispensed with and communication may be established direct to the machine bus, to the section controller, or to the section bus.

Very much to advantage, besides making use of the communication and control structure of the textile machine, is that also an existing power supply can be put to use on the textile machine for the electronic elements of the workstations. Besides sparing the costs of connection for the communication, additionally the wiring costs for a separate, individual electrical current supply are also avoided.

In the case of the procedure for transmission of sensor data where a textile machine is concerned, in accord with claim 12, the tranmission of sensor data, at least batchwise, is accomplished by a machine bus of the textile machine. As mentioned above, also in this case, a separate communication structure for the central evaluation of the sensor data may be discarded.

With the aid of the drawing, embodiments of the invention are explained in greater detail. There is shown in:

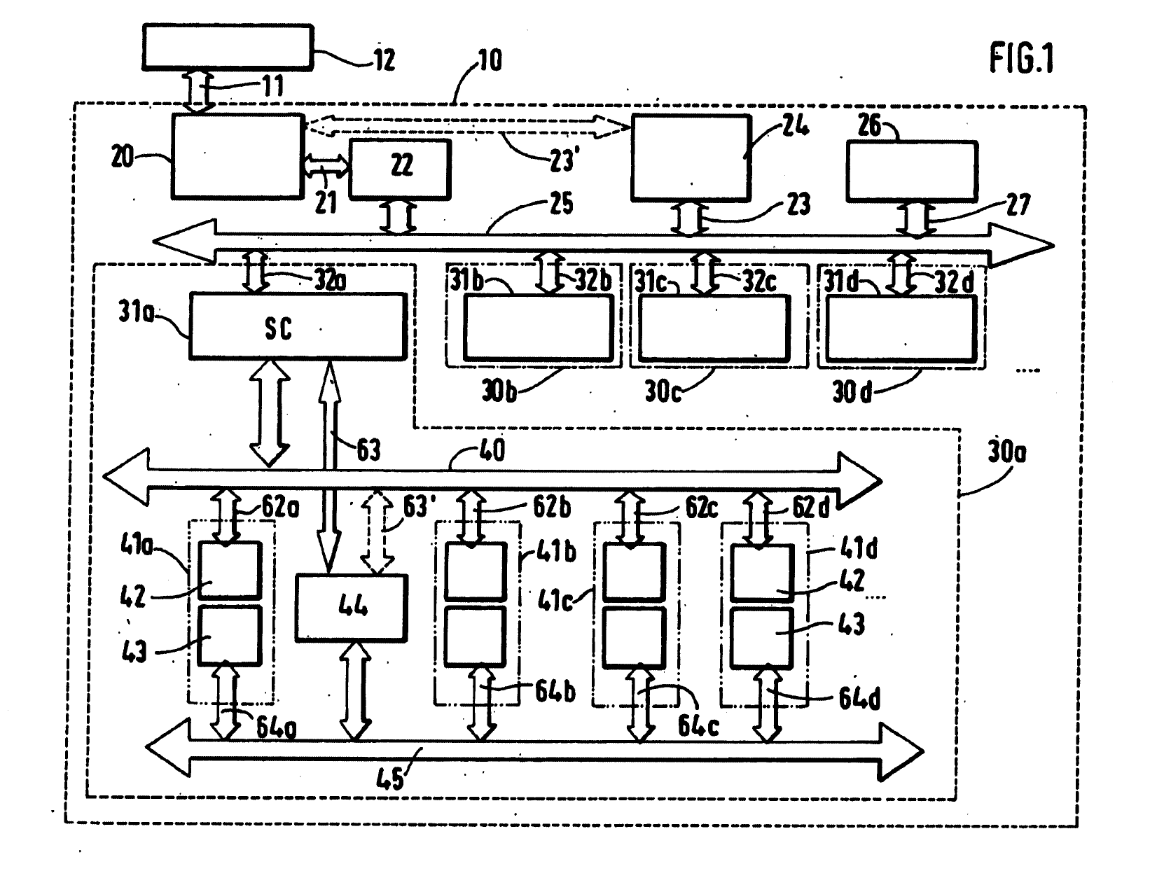

FIG. 1 a communication structure for a spinning machine for the transmission of quality data in accord with a first embodiment,

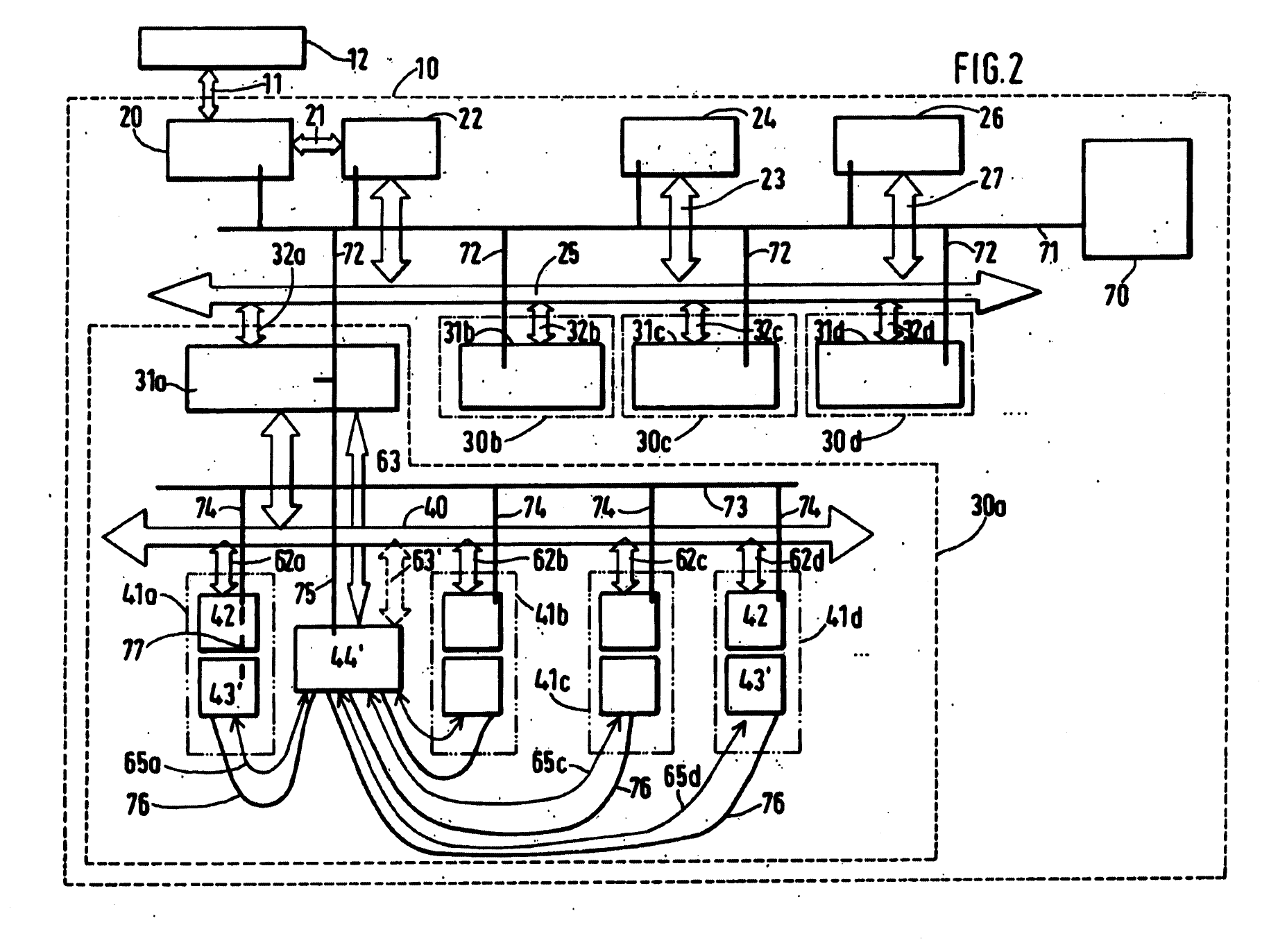

FIG. 2 a communication structure in accord with a second embodiment wherein further a supply network is presented, and

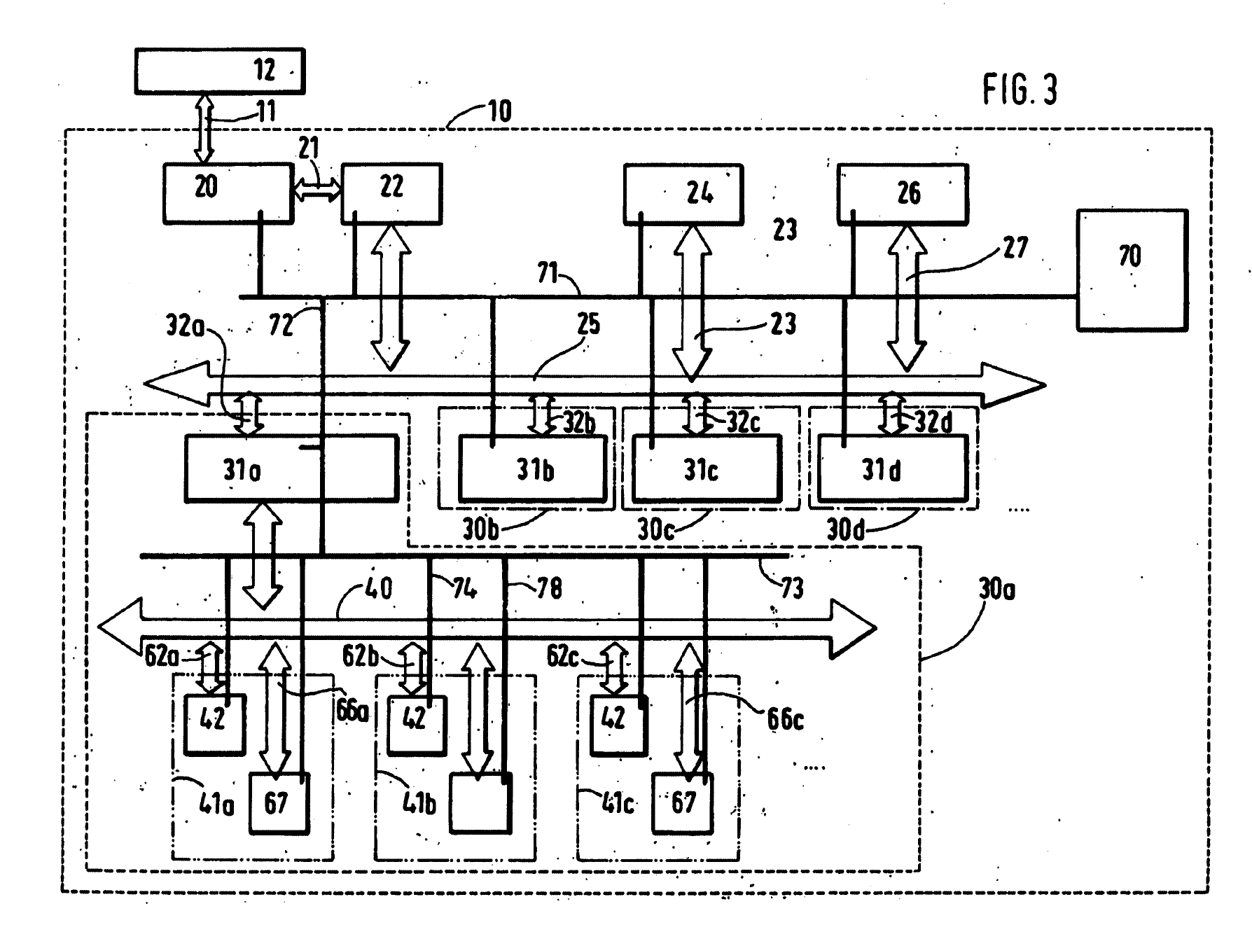

FIG. 3 a communication structure in accord with a third embodiment example.

FIG. 1 shows, in a schematic manner, a communication structure in accord with a first embodiment for an open-end spinning machine 10. The open-end spinning machine is controlled by a central machine control 20. Optionally, this central machine control 20 can be connected through an external line 11 to a general works control 12. The works control 12 regulates or controls, for example, several parallel operating spinning machines 10 or pre/post-positioned workstations of the spinning machine. The machine control 20 is in communication by a line 21 for data exchange with a CAN-distributor 22 (router). For the data exchange between the elements of the spinning machine 10, the CAN-distributor 22 operates through a machine bus 25 (CAN-bus). By a communication line 23, a central quality evaluation unit 24 is connected to the machine bus 25. The central quality evaluation unit 24 further stands in connection through a still to be described communication structure with thread cleaners 43 for data exchange. The quality evaluation unit 24 operates independently from the central machine control 20, although it can both send and receive control data therefrom.

Instead of the communication line 23, in another embodiment, provision can be made for a communication tie link 23′ directly between the machine control 20 and the evaluation unit 24. The communication line 23 is, however, to be preferred, since this relieves the central machine control 20 of nothing more than simple data passage from the bus 25 to the said evaluation unit 24. Further, the evaluation unit 24 can be installed spatially independently of the machine control 20.

In addition on the machine bus 25 and connected by communication line 27 is a service cart 26 with a start-up aggregate for the spinning machine 10. Additionally, although not shown here, startup robots are likewise connected by communication line to the machine bus 25.

The spinning stations 41a-d are combined groupwise in a section 30a-d, whereby in FIG. 1, only the spinning stations 41a-d and the section 30a are shown in detail. Each section includes a section controller 31a-d, whereby each section controller 31a-d is connected respectively by communication line 32a-d to the machine bus 25. Each section controller 31a-d also exercises a router function for the data exchange between a section bus 40 and the machine bus 25. In this way, the section bus 40 is controlled from the section controller 31a. A section electronic device 42 as well as a thread cleaner 43 is assigned to each spinning station 41a-d. Each spinning station 41a-d is connected by a communication line 62a-d to the section bus 40. To each section electronic device 42, for example, is connected a thread monitor, which monitors thread-presence at the spinning station. The section electronic device 42, being equipped with appropriate sensors and actuators, is also connected to a feeding means, which, for example, inserts a fiber matting band into a disintegrating roll at the spinning station. The communication structure of the spinning machine 10, as described up to this point, is identical to that of the second and third embodiments as presented in FIGS. 2 and 3. In the following, on this account, the described elements are provided with the same reference numbers.

In the case of the first embodiment, according to FIG. 1, the thread cleaners 43 are in connection with a cleaner bus 45 through the tie-lines 64a-d. Similar to the section controller 31a, the cleaner bus is controlled and operated by a cleaner section unit 44. The cleaner section unit 44 has primarily a router function, although it can also, in a sectional manner, evaluate the data transmitted from the thread cleaners 43 and, in some cases, transmit control data especially to the section controller 31a, in order, for example, to act through the section electronic device 42 on the operation of the spinning stations 41a-d.

The cleaning section controller 44 is connected directly by a communication line 63 with the section controller 31a or, in a preferred formulation, by means of a communication line 63′ to the section bus 40 through the said section controller 31a . With this communication structure, communication is effected between the evaluation unit 24 and a thread cleaner 43 through the communication line 23 (that is to say, the communication line 23′, the machine control 20 to the distributor 22) to the machine bus 25, the communication line 32a-d, the section controller 31a-d, the section bus 40 and the communication line 63′ (or the communication line 63) the cleaning section unit 44, the cleaning bus 45, the communication line 64a-d and finally to the thread cleaner 43. Correspondingly, the communication can run in the reversed order.

Examples for the data exchange are stated in the following: From the evaluation unit 24, a software download/upload is carried out for the thread cleaner 43 as a downlink through this communication structure to the thread cleaner 43. Or, in a batch, i.e., a party-exchange at the spinning machine 10, (that is, upon the alteration of the quality or the kind of thread to be produced by the spinning station) new adjustment parameters for thread cleaning are transmitted in the downlink from the quality evaluator to the thread cleaner 43.

In the case of the embodiment presented here, each thread cleaner 43 possesses its own integral evaluation processor along with a communication processor, so that the thread quality, which has been captured in analog form by means of the sensor component of the thread cleaner 43, is converted to digital values and subjected to a preliminary evaluation. The preliminary evaluation embraces, among other things, a classification of the measured thread value, as this is generally known, the determination of thread faults, and if a thread break need be carried out. These quality values, i.e., control data, are then transmitted from uplink through the communication structure from the thread cleaner 43 to the central evaluation unit 24. If, beyond this, for instance at the spinning station 41a the thread quality requires an artificial thread break, then from the thread cleaner 43 a corresponding control demand is made over the communication line 64a, the bus 45, the cleaning section unit 44, the communication connection 63′, the section bus 40 to the section electronic device 41a (or through the alternate path of the section controller 31a in case of the connection 63). The completion of this message then releases by control means of the feed of the fiber band (stop demand) an artificial thread break. At the same time, of course this information is further forwarded to the evaluation unit 24 for the statistical evaluation.

The central quality evaluation unit 24 then produces statistic data from the input of quality and/or control data For example, it calculates average or absolute quality schemata in the form of the known quality matrices, this is either concerning a single spinning station 41a-d, sectionwise 33a or is valid for all spinning stations of the spinning machine 10. Along with this. it is also possible that spectrograms, CV-values and the like can also be determined with reference to spinning stations, sections, or spinning stations. This form of the communication and evaluation is also valid, especially for the further embodiments.

FIG. 2 demonstrates a communication structure according to a second embodiment This represents partially, that of FIG. 1, with the difference, that in this case the electrical current feed to the individual section electronic devices 42 and the thread cleaners 43 is additionally shown and the communication between the thread cleaners 43′ and the cleaner section unit 44′ deviates from that of FIG. 1. The supply of current, however, is applicable to the structure of FIG. 1.

In this case, the thread cleaners 43′ stand individually communicatively connected through connections 65a-d in star-shaped arrangement with cleaner section unit 44′. The thread cleaners 43′ could be designed in accord with the thread cleaners 43, wherein the communication over connection 65a-d would be carried out in a digital exchange. Advantageously, however, the thread cleaners 43′ are analog sensor heads and by the communication connection 65a-d, principally control-potentials are applied from the cleaning section unit 44′ onto the thread cleaners 43, and conversely, by means of the communication connection 65a-d analog values of the thread cleaner are transmitted to the cleaner section unit 44′. In this case, the tread cleaners operate as sensor heads without themselves processing the measured values. The necessary evaluation is then accomplished by the cleaner section unit 44, so that from that source, corresponding control data and quality data for each spinning station 41a-d are made available. The transmission from the said cleaner section unit 44′, for example, to the central evaluation unit 24 is executed analogously to the path described for FIG. 1, and likewise, the downlinks from the evaluation unit 24 to the cleaner section unit 44′. In this case the adjustments, that is, software updates, are not undertaken in the thread cleaners 43, but rather in the cleaner section unit 44′

Further, in FIG. 2 a current supply structure is presented. The voltage supply runs from one central current supply unit 70 through cable 71, parallel to the machine bus 25, and from cable 71 through the branches 72 to the section controllers 3a-d.

In this way, the current supply unit 70 can make available a plurality of supply potentials (for instance, 24 volt, 50 volts or 12 volts) by means of the cable 71, or principally produce only one supply potential, namely 24 volts. In each section controller 31a-d,s there is provided a terminal for energy supply. Further, the branches 72 are extended to a distributor cable 73, which also runs parallel to the section bus 40. From the distributor cable 73 run again branches 74 to each spinning station electronic 42, which then supplies the sensors and actuators with voltage. Further a line 75 branches off of the distributor cable 73 which delivers potential to the tread cleaner section unit 4 4′. Up to now, the corresponding structure is interchangeable with that of FIG. 1. Power lines 76, in star connection, run from the cleaner section unit 44′ parallel to the communication connections 65a-d and supply the thread cleaners 43′. Parallel, in the sense of the description is to be interpreted as not necessarily physically parallel, but rather parallel in relation to the communication structure. From the state of the construction, of the spinning machine, however, a physical parallel lay of the lines is also of merit, since then energy supply and communication lines can be bundled together.

In a further embodiment, it is possible that instead of the lines 76, even branching can be carried out by the extension of the spinning station electronic 42 to the thread cleaners 43.

FIG. 3 shows a third embodiment of the communication structure, with a further layout design of the current supply system. In deviation from FIG. 1, in this case omissions included the connections 63 and/or 63′, the cleaning section unit 44 and the cleaner bus 45. Instead of the communication ties 64a-d to the cleaner bus 45, in this case the thread cleaner is connected directly to the section bus 40 by means of the communication tie 66a-d. Similar to the case of the first embodiment, the thread cleaner 67 includes here an evaluator electronic system, with which, possibly, analog measurement data are converted to digital measurement data and are then subjected to a preliminary evaluation. These data are then transmitted through a communication apparatus in the measuring head through the communication connection 66a-d to the section bus 40. Data and control data are then available from this bus 40.

In the case of the power distribution structure of FIG. 3, the thread cleaners 67 are connected to the distributor 73 by tie lines 78. Such a structure can also be provided which corresponds to the structures of FIG. 1 and FIG. 2.

Claimed is:

1. A textile machine with a multiplicity of workstations (41a-d), each having one electronic device (42) per station, a central machine control (20, 22) a machine bus (25) for communication between the machine control (20, 22) and each, or possibly a group (30a-d) of electronic devices (42) and a sensor apparatus (43, 43′, 67) for each appointed workstation (41a-d), characterized by a central evaluation unit (24) for the evaluation of sensor data from the sensor apparatuses (43, 43′, 67),
wherein the sensor data encompass characteristic values continually measured by the sensor apparatus, and/or values therefrom derived quality or signal data regarding a processed or produced product from the workstation (41a-d),
wherein the central evaluation apparatus (24) is connected by a first communication connection (23, 23′) with the machine control (20, 22) or the machine bus (25),
wherein each sensor apparatus, by means of a second communication connection (23/23′:21:22; 25, 31a-d, 40:63′/63:44/44′:45:64a-d; 40:66a-d) is connected with the evaluation unit (24) and
wherein the second communication connection encompasses at least the machine bus (25) and the first communication connection (23, 23′).

2. A textile machine in accord with claim 1, therein characterized, in that the second communication connection (23/23′:21:22; 25, 31a-d, 40:63′/63:44/44′:45:64a-d; 40:66a-d) is bidirectional.

3. A textile machine in accord with claim 1 or 2, therein characterized, in that each group (30a-s) of electronic devices (42) of the workstations (41a-d) is connected by a section controller (31a-d with the machine bus (25).

4. A textile machine in accord with claim 3, therein characterized, in that each electronic device (42) of a group (30a-d) of electronic devices (42) is connected by a section bus (40) with the section controller (31a-d.

5. A textile machine in accord with claim 3 or 4, therein characterized, in that, a group of sensor apparatuses (43, 43, 67), especially one of the group (30a-d) of electronic devices (42) of the group of sensor apparatuses, corresponding to workstations, is connected with a section controller (31a-d by means of a third communication connection (40:63′/63:44/44′:45:64a-d65a-d) of the group of control apparatuses, whereby the second communication connection includes the third communication connection or includes the section bus (40) and the third communication connection.

6. A textile machine in accord with claim 5, therein characterized, in that the group of sensor apparatuses (43, 43′) is connected with a sensor section unit (44, 44′) and the third communication connection encompasses a fourth communication connection (63, 63′) between the section controller (31a-d or the section bus (40) and the sensor unit (44, 44′).

7. A textile machine in accord with one of the foregoing claims, therein characterized, in that each sensor apparatus (43, 67) has a communication unit and/or an evaluation unit for the assessment of captured measured values and for making available sensor data which can be evaluated by the central evaluation unit (25).

8. A textile machine in accord with one of the foregoing claims, characterized by a current supply source (70) for the availability of the supply voltage(s) for the electronic devices (42) and sensor apparatuses (43, 43, 67).

9. A textile machine in accord with claim 8, therein characterized, in that a central main distribution cable (71) runs from the current supply source (70) along the multitude of workstations (41a-c) and both the sensor apparatuses (43, 43′67) as well as the electronic devices are connected with the said central main distribution cable (71).

10. A textile machine in accord with claim 9, therein characterized, in that respectively a group (30a-d) of electronic devices (42) of the workstations (41a-c) are connected with a section controller (31a-d), whereby, originating from the central main distribution cable (71) a branching line (72) leads to each section controller (31a-d) and both the sensor apparatuses (43, 43′, 67) as well as also the electronic devices (42) are connected by distribution lines (73, 74, 75, 76, 77, 78) with the section unit in order to make available the supply voltage(s).

11. A textile machine in accord with claim 9 or 10, therein characterized, in that respectively, a group (30a-d) of sensor apparatuses (43, 43′) are connected with a sensor section unit (44, 44′), which, is connected with the section controller (31a-d or the central main distribution line (71) for the purpose of making available supply voltage(s).

12. A procedure for the transmission of sensor data and/or quality or signal data derived therefrom, in a textile machine (10), wherein the textile machine possesses:
a multiplicity of workstations (41a-d),
an electronic device (42) per workstation,
a central machine control (20, 22),
a machine bus (25) for communication between the machine control (20, 22) and each electrode unit (42) or a group (30a-d) thereof,
a sensor apparatus (43, 43′, 67) placed in each workstation
a central evaluation unit (24) for the evaluation of the sensor data of the sensor apparatuses (43, 43′, 67), whereby the sensor data embraces continually measured characteristic values and/or quality or signal data derived therefrom relating to a product processes by or produced by one of the workstations,
and whereby:
the central machine control (20, 22) for the regulation of a workstation (41a-d) transmits control data by means of a first communication connection (25, 32a-d, 31a-d, 40, 62a-d) to the electronic devices (42) of the said workstations, wherein the first communication connection encompasses the machine bus (25).
the central machine control (20, 22) receives condition data from the electronic devices (42) regrding the operational state of a workstation through the first communication connection,
the central evaluation unit (24) for the control and/or the adjustment of the sensor apparatuses (43, 43′, 67) transmits control or adjustment data through a second communication connection (23/23′:20:22, 25, 32a-d, 31a-d, 40:63′/63:44/44′:45:64a-d/65a-d; 40:66a-d) to the sensor apparatuses, wherein the second communication connection embraces the machine bus (25), and
the central evaluation unit (24) receives sensor data from the sensor apparatuses (43, 43′, 67) through the second communication connection.
